(19) United States
(12) Patent Application Publication
(10) Pub. No.: US 2020/0012772 A1
(43) Pub. Date: Jan. 9, 2020

(54) SYSTEMS AND METHODS FOR MATCHING IDENTITY AND READILY ACCESSIBLE PERSONAL IDENTIFIER INFORMATION BASED ON TRANSACTION TIMESTAMP

(71) Applicant: TINOQ Inc., San Jose, CA (US)

(72) Inventors: Young Geun CHO, Palo Alto, CA (US); Chan Soo HWANG, Sunnyvale, CA (US); Daxiao YU, Cupertino, CA (US)

(73) Assignee: TINOQ Inc., San Jose, CA (US)

(21) Appl. No.: 16/458,787

(22) Filed: Jul. 1, 2019

Related U.S. Application Data
(60) Provisional application No. 62/693,892, filed on Jul. 3, 2018.

(51) Int. Cl. G06F 21/32; G06F 17/16; G06F 21/62

(52) U.S. Cl. CPC G06F 21/32; G06F 21/6245; G06F 17/16

(57) ABSTRACT

Described herein are systems and methods that may identify a personal and their activities in a facility where the access is limited to members. Matching transaction information and readily accessible personal identifier information such as biometric and/or non-biometric information provides an identification process without requiring user to cooperate in information acquisition. A method may comprise: collecting a timestamp of a transaction of a member; collecting readily accessible personal identifier information of the member with their associated transaction information; computing one or more similarity scores based on the collected readily accessible personal identifier information and historical readily accessible personal identifier information; and determining if there is a match between transaction information and the collected readily accessible personal identifier information based on the one or more similarity scores. In some embodiments, the facility may be a physical fitness facility

### CROSS REFERENCE TO RELATED PATENT APPLICATIONS

The present application claims priority benefit, under 35 U.S.C. § 119(e), to co-pending and commonly-assigned U.S. Patent Application No. 62/693,892, filed on Jul. 3, 2018, entitled “SYSTEMS AND METHODS FOR MATCHING IDENTITY AND READILY ACCESSIBLE PERSONAL IDENTIFIER INFORMATION BASED ON TRANSACTION TIMESTAMP,” listing as inventors Young Geun Cho, Chan Soo Hwang, and Daxiao Yu, which application is herein incorporated by reference as to its entire content. Each reference mentioned in this patent document is incorporated by reference herein in its entirety.

### BACKGROUND

### A. Technical Field

The present disclosure relates generally to systems and methods for autonomously identifying a person based on biometric and/or non-biometric information, and more particularly identifying a person and their activities in a facility where the access is limited to members, such as physical fitness facility.

### B. Background

The demographic information of a member of a facility where the access is limited to members, such as name, gender, date of birth, address, etc., may be revealed during transactions such as swiping credit card, use of membership card, login to communication systems, and/or entering login information to a kiosk. Usual demographic information revealed during a transaction may not contain readily accessible personal identifier information such as biometric information and/or non-biometric information, which may be useful to track activities of members within the premise or to acquire labeled biometric data for investigation. For example, without biometric information such as profile pictures, it may be very difficult to track if this member attends certain classes in a gym or uses particular types of equipment. In another example, without a voice signature, it is very difficult to authenticate a user with a device that only has mic as an input device.

Accordingly, what is needed are systems and methods that may improve the accuracy of identifying a member and their activities in a physical fitness facility and other environments.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments. Items in the figures are not to scale.

Figure (“FIG.”) 1A and FIG. 1B depicts a flowchart for matching readily accessible personal identifier information such as biometric and/or non-biometric information and a member's identity based on the similarity scores according to embodiments of the present document.

FIG. 2 depicts flowchart for extracting matches from a correlation matrix based on successive cancellation according to embodiments of the present document.

FIG. 3 depicts a simplified block diagram of a computing device/information handling system, in accordance with embodiments of the present document.

### DETAILED DESCRIPTION OF EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method on a tangible computer-readable medium.

Components, or modules, shown in diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” or “communicatively coupled” shall be understood to include direct connections, indirect connections through one or more intermediary devices, and wireless connections.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated.

The terms “include,” “including,” “comprise,” and “comprising” shall be understood to be open terms and any lists the follow are examples and not meant to be limited to the listed items. Any headings used herein are for organizational purposes only and shall not be used to limit the scope of the description or the claims. Each reference mentioned in this patent document is incorporate by reference herein in its entirety.

Furthermore, one skilled in the art shall recognize that: (1) certain steps may optionally be performed; (2) steps may not be limited to the specific order set forth herein; (3) certain steps may be performed in different orders; and (4) certain steps may be done concurrently.

A. Objectives

One primary objective of matching transaction information and readily accessible personal identifier information such as biometric and/or non-biometric information is to provide systems and methods that can collect readily accessible personal identifier information without requiring user to cooperate in information acquisition. The system should be capable of authorizing access to the readily accessible personal identifier information such as biometric and/or non-biometric information, autonomously collect the information, and authenticate, or validating the information. In some embodiments, the systems and methods may be utilized in a facility where access is limited to members. One example, but without limitation, may be a physical fitness facility. As used herein, readily accessible personal identifier information may include biometric information and non-biometric information. Non-biometric information may include ear buds, glasses, earrings, clothes, bags, hats, and signatures of electronic device. Transaction information may be referred to as transaction data.

In an embodiment, readily accessible personal identifier information is the picture of a member. A conventional way of collecting a profile picture for a physical fitness or gym member may be to ask the member to visit a special booth and stare at the camera for a period of time and generate a profile picture. Because it is inconvenient, many members may choose not to provide profile pictures. In another example, a physical fitness facility or gym may ask the members to upload other profile pictures to the webpage of the gym, which unfortunately may result in unauthenticated profile pictures (e.g., sometimes picture of dogs or cats are submitted). Such profile pictures cannot be used for applications that need authentication. Using validated biometric information, a business owner can monitor member activities in the premises of the gym in order to improve the quality of service. Moreover, the matching results can serve other business purposes such as fraud member detection or activity validation for an insurance company. The biometric information can be used to authenticate user's activities or to authenticate transactions when only biometric input device is available. In some embodiments, the gym may include multiple cameras to assist is facial recognition based on profile pictures.

In general, a ‘profile picture’ may be an example of biometric information that is a type of readily accessible personal identifier information. As an example, but without limitation, biometric information may include one of more of the following: profile picture, voice profile, fingerprint, gait, and other features that can be uniquely mapped to the individual or member. As an example, but without limitation, non-biometric information may include accessories (ear buds, glasses, earrings), clothes, bags, hats, etc., and signatures of electronic devices. The signatures of the electronic devices may be based on the MAC address, Bluetooth address (BD_ADDR), or other unique ID of the electronic devices. Electronic devices may include, for example, but without limitation, smart phones and smart watches. As described herein, use cases in gyms are utilized to describe embodiments in this disclosure. In general, some embodiments can be used in any facilities where the access is restricted to members where a member is an individual who has right to enter such space. The membership can be temporary; for example, a guest to an amusement park can be considered as a member because the individual entered an access controlled space with the amusement park's consent. The membership can be implicit; for example, a shopper who entered to a shop is considered as a member because the individual entered a space where the access is limited by access control devices such as security gate, door, or guard. For some embodiments, it may be useful to access premises or services based on members' transaction information such as membership card, credit card, login to communication systems such as Wi-Fi, etc. Other embodiments may use check-in as a transaction, where the transaction may include the use of credit card, membership card, login-to communication systems, entering login information at a kiosk, providing credential to remote server on a mic, etc.

Some embodiments may provide a solution for matching identity of a member and profile picture by correlating check-in timestamps and recognized faces acquired over multiple visits. As a result of a matching process, a member profile may be established with profile pictures in addition to previously collected information through the membership subscription. Other embodiments may apply to a case where a picture profile was previously provided to the gym. These embodiments may be used to add more profile pictures, or replace outdated pictures that are not useful to recognize members in the premise.

B. Matching System Overview

Matching system may include data collection, similarity score computing/collection and matching analysis: The data collection step may comprise: 1) collect transaction information (e.g., timestamp, member identification, transaction location, transaction type, and/or other information disclosed during the transaction) and readily accessible personal identifier information such as biometric and/or non-biometric information. Biometric information may comprise pictures of the persons who were near the location of transaction. (2) collect the score that measures the similarity of acquired accessible personal identifier information and the previously acquired accessible personal identifier information. In one embodiment using picture as biometric information, picture scores may measure the similarity of the current picture and the historical pictures that may belong to the member of the current transaction. Other biometric data may be collected in lieu of or in addition to biometric data such as pictures. Also, non-biometric readily accessible personal identifiable information may be collected and then be used to produce the similarity score. Sources of non-biometric information may include, but without limitation accessories (ear buds, glasses, earrings), clothes, bags, hats, etc., and signatures of electronic devices. The signatures of the electronic devices may be based on the MAC address of the electronic devices. Electronic devices may include, for example, but without limitation, smart phones and smart watches. Then, 3) build a record that measures the correlate the check-in record and the profile pictures. In an embodiment, the correlation record can be a two-dimensional matrix of size [the number of members] by [the number of picture profiles], where (i, j) entry of the matrix represents an accumulated score between member i and picture profile j over data collection duration. Data collection can run over a period of time that is sufficient to obtain multiple check-in and picture samples.

The matching analysis step may comprise: based on scores of matrix entries, matches, (member ID, picture profile ID) pairs, are extracted. Some embodiments are presented in this disclosure, but the method is not limited to the embodiments discussed herein.

In addition to the aforementioned major steps, other minor steps are also described herein along with variations and extensions.

C. Matching System Description

Definitions and assumptions
member: a member ID in club's member system. Member is supposed to check-in at the front desk every time he/she visits the premise.
picture profile: a set of pictures for one member. This can be one picture, or multiple pictures. Assume that picture profiles are already built, but not paired with a member yet.
match: a pair of (member ID, picture profile ID) for one real person.

Notations: The member's data includes information on member identification, picture profiles, picture indexes, check-in events, number of check-in events for member, timestamp for check-in events for member, and timestamp for pictures.
i: member i
j: picture profile j
n: picture index n
k: check-in event k
K(i): the number of check-in for member i
t(i, k): timestamp for check-in event k for member i
T(n): timestamp for picture n

### 1. Detailed Steps

A. Pre-Processing

For each member i, check-in timestamps t(i,k) is collected. For each picture n, picture taken time, T(n) is collected.

For each picture, similarity score is computed against all picture profiles. S(n, j) denotes the similarity score between picture n and picture profile j. Higher similarity means higher probability that the same person is in the picture and the picture profile. For each picture n, S(n,j) is recorded for top M scores. M can be between 1 and the number of picture profiles. Scores outside top M are recorded as zero. S(n,j) is computed based on face recognition technology and other additional information

B. Building a Correlation Matrix M(i,j)

For member i, check-in timestamp t(i, k) is given for k=0, . . . , K(i)−1.

For timestamp t(i,k), summation of picture scores is computed as follows:

M(i,j,k)=sum of S(n, j)*w(t(i,k),T(n)) over all pictures.

Note that weight function w(t1, t2) is between 0 and 1, evaluating the timing delta between the picture taken time and the check-in time. This function is a tunable function depending on configuration of check-in system, locations of cameras collecting pictures, and any time drift between camera and check-in system. Usually, this function is non-zero only when t1 and t2 are close enough, e.g. tens of seconds. As this weight is zero for pictures taken outside this small window, computation complexity may not be significant.

Finally, M(i,j) is the sum of scores for all check-in events:

M(i,j)=sum of M(i,j,k) over k=0, . . . , K(i)−1.

C. Extracting Matches from Matrix Processing

This process is called successive cancellation, described as follows:

a) Pick the best match (i′,j′) from the matrix. If the best match (i′,j′) satisfies a certain criteria, declare (i′, j′) as a match and go to step b). If the best match (i′,j′) does not satisfies a certain criteria, declare (i′, j′) as not a match and terminate the process.

b) Delete row i′ and column j′ from the matrix and repeat step a)

Best match may be based on the score M(i,j) and other factors. For example, the best match can be (i′,j′) with the highest score for the matrix, i.e., (i′,j′)=arg max M(i,j) over all (i,j) combinations. On the other hand, more complicated schemes can be used. For example, (i′,j′) can be the one with the highest distance from the second best score within row i′. More specifically, this can be done in two steps. Step I. for each row i, pick j1(i) and j2(i) corresponding to the biggest and the second biggest entries in M. Then, compute the distance metric for row i as follows: d(i)=M[i,j1(i)]−M[i,j2(i)]. Step II. Pick i′ with the biggest distance metric: i′=arg max d(i) over all rows. Then, set j′=j1(i).

Stopping processing at step a can be done with various methods. For example, stop processing if M(i′,j′) is lower than a pre-determined threshold value. Or stop processing if the delta between M(i′,j′) and the second best score within row i′ is less than another threshold.

### 2. Variations and Extensions

Picture vs. group of pictures. Similarity score S(n, j) can be computed per picture, or a group of pictures belonging to a same person. For example, facial tracking can generate series of pictures belonging to the same person. In this case, one representing score can be computed for this group of pictures and used for matching.

Invalidation of matches. Embodiments of the present disclosure may generate matches, but also may generate erroneous matches. To improve the correctness of matches, some matches are invalided (de-matched) under certain conditions. For example, assume there is a match (i,j). If many pictures show high similarity score against picture profile j, but these are not corresponding check-in record for member I around picture taken timestamps, the match (i,j) is not strong. In this case, this match (i, j) can be invalidated.

### 3. Figures and Embodiments

FIG. 1A and FIG. 1B depicts flowchart 100 and flowchart 200 for matching readily accessible personal identifier information that includes biometric and/or non-biometric information and a member's identity based on the similarity scores according to embodiments of the present document. The method comprises the following steps:

Collecting associated transaction information including a timestamp of a member's transaction. (step 102)

Collecting, by one or more sensors and a processor, readily accessible personal identifier information of the member with timestamp that includes biometric and/or non-biometric information of the member. (step 104). The biometric information may be acquired from one or more sensors. The one or more sensors may comprise one or more cameras operable to acquire one or more images for facial recognition. Sources of non-biometric information may include accessories (ear buds, glasses, earrings), clothes, bags, hats, etc., and signatures of electronic devices.

Computing, by the processor, one or more similarity scores based on the current collected information and historical readily accessible personal identifier information that includes biometric and/or non-biometric information that was collected from the member's previous transactions. (step 106)

Is there a match between readily accessible personal identifier information that includes biometric and/or non-biometric information and member's identity based on the one or more similarity scores based on the member's previous transactions? (step 108)

If NO, repeat collecting (step 102).

If YES, validate the member's identity (step 110).

Collecting, by one or more other sensors, other readily accessible personal identifier information that includes biometric and/or non-biometric information of member's activity in a member's facility. (step 120)

Communicating the member's status and activities at the member's facility to a third party. (step 122)

For step 108, the determination of a match may be based on several combinations of parameters. For example, but without limitation, the combinations of parameters may include: 1) the transaction information and the collected biometric information, or 2) the transaction information and the collected non-biometric information, or 3) the transaction information and the collected biometric information and the collected non-biometric information, or 4) item 3) and the historical biometric information. Each result 1), 2), 3) and 4) is compared to the identity of the member based on the one or more similarity score to determine a matching status.

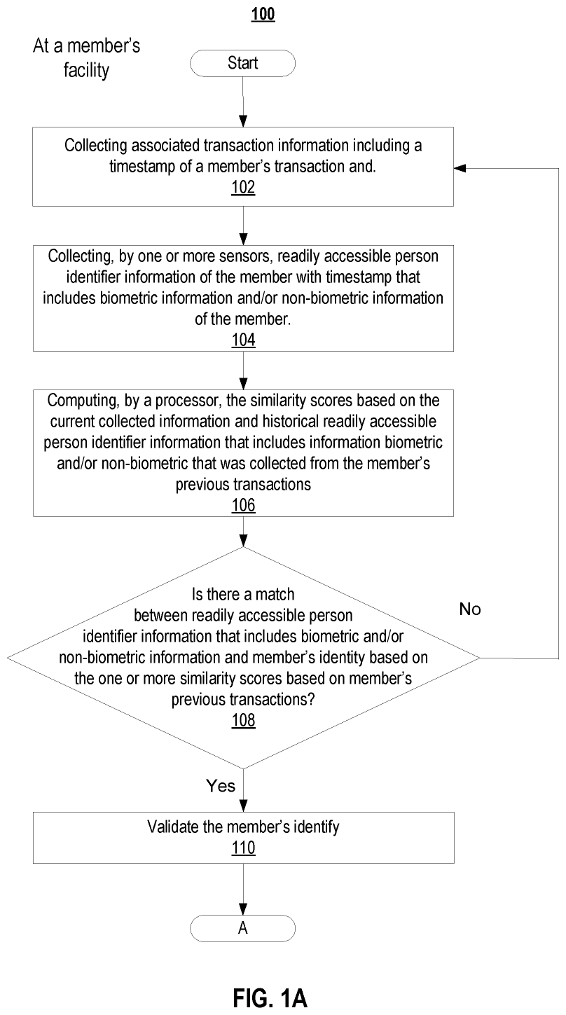

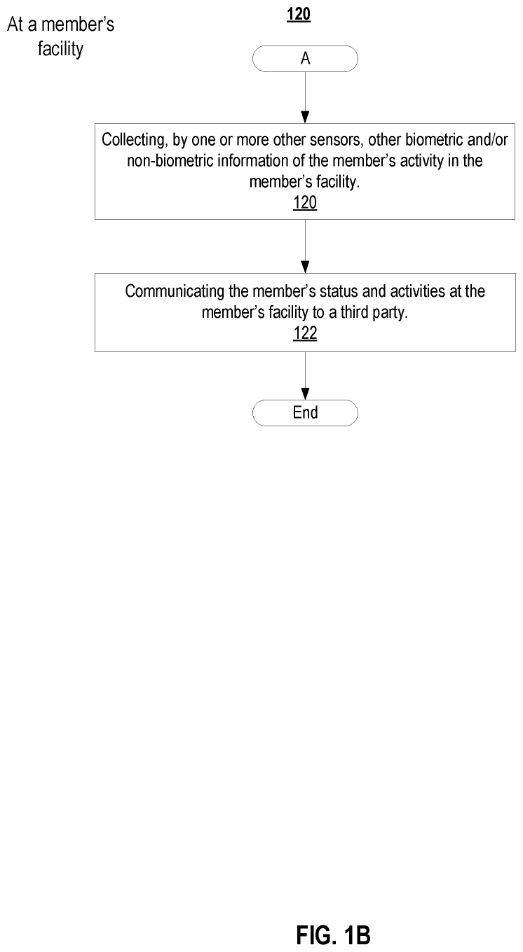

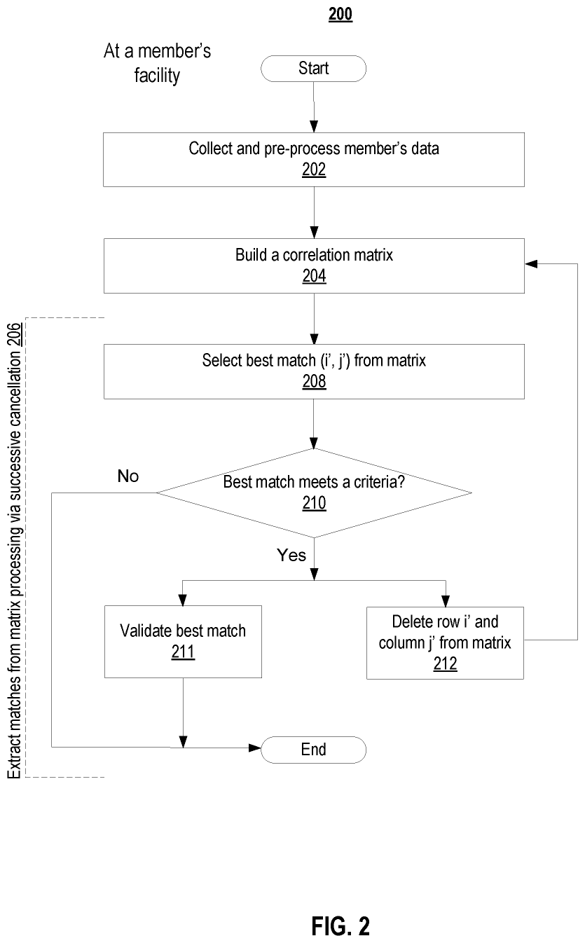

FIG. 2 depicts flowchart 200 for extracting matches from a correlation matrix based on successive cancellation according to embodiments of the present document. The method comprises the following steps:

Collect and pre-process member's data. (step 202)

Build a correlation matrix. (step 204)

Extract matches from matrix processing via successive cancellation. (step 206). Step 206 comprises the steps of 208, 210, 211, and 212.

Select best match (i′, j′) from the correlation matrix based on a sum of scores for all check-in events. (step 208)

Does the best match meet a criteria? (step 210)

If YES, validate the match (step 211)

If YES, delete row i′ and column j′ from correlation matrix. (step 212), and repeat step 204. That is, if the best match does meet the criteria, delete the most recent member identification and picture profile from the correlation matrix, recalculate the correlation matrix, then select the a next best match from modified correlation matrix.

If NO, end method.

D. System Embodiments

In embodiments, aspects of the present patent document may be directed to or implemented on information handling systems/computing systems. For purposes of this disclosure, a computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data for business, scientific, control, or other purposes. For example, a computing system may be a personal computer (e.g., laptop), tablet computer, phablet, personal digital assistant (PDA), smart phone, smart watch, smart package, server (e.g., blade server or rack server), a network storage device, or any other suitable device and may vary in size, shape, performance, functionality, and price. The computing system may include random access memory (RAM), one or more processing resources such as a central processing unit (CPU) or hardware or software control logic, ROM, and/or other types of memory. Additional components of the computing system may include one or more disk drives, one or more network ports for communicating with external devices as well as various input and output (I/O) devices, such as a keyboard, a mouse, touchscreen and/or a video display. The computing system may also include one or more buses operable to transmit communications between the various hardware components.

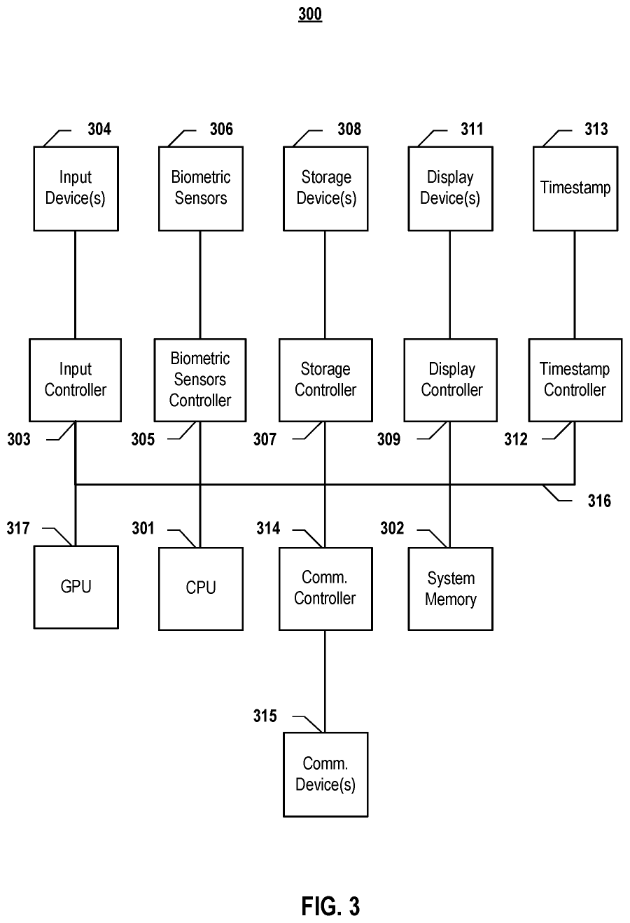

FIG. 3 depicts a simplified block diagram of a computing device/information handling system (or computing system) according to embodiments of the present disclosure. It will be understood that the functionalities shown for system 300 may operate to support various embodiments of an information handling system—although it shall be understood that an information handling system may be differently configured and include different components.

As illustrated in FIG. 3, system 300 includes one or more central processing units (CPU) 301 that provides computing resources and controls the computer. CPU 301 may be implemented with a microprocessor or the like, and may also include one or more graphics processing units (GPU) 317 and/or a floating point coprocessor for mathematical computations. System 300 may also include a system memory 302, which may be in the form of random-access memory (RAM), read-only memory (ROM), or both.

A number of controllers and peripheral devices may also be provided, as shown in FIG. 3. An input controller 303 represents an interface to various input device(s) 304, such as for example, but without limitation, a keyboard, mouse, stylus, or other sensors. Input device(s) 304 may collect non-biometric information. There may also be a biometric sensor controller 305, which communicates with a biometric sensor 306. A biometric sensor 306 may be a camera. System 300 may also include a storage controller 307 for interfacing with one or more storage devices 308 each of which includes a storage medium such as magnetic tape or disk, or an optical medium that might be used to record programs of instructions for operating systems, utilities, and applications, which may include embodiments of programs that implement various aspects of the present invention. Storage devices 308 may also be used to store processed data or data to be processed in accordance with the invention. System 300 may also include a display controller 309 for providing an interface to a display device 311, which may be a cathode ray tube (CRT), a thin film transistor (TFT) display, or other type of display. The computing system 300 may also include a timestamp controller 312 for communicating with a timestamp 313. A communications controller 314 may interface with one or more communication devices 315, which enables system 300 to connect to remote devices through any of a variety of networks including the Internet, a cloud resource (e.g., an Ethernet cloud, an Fiber Channel over Ethernet (FCoE)/Data Center Bridging (DCB) cloud, etc.), a local area network (LAN), a wide area network (WAN), a storage area network (SAN) or through any suitable electromagnetic carrier signals including infrared signals.

In the illustrated system, all major system components may connect to a bus 316, which may represent more than one physical bus. However, various system components may or may not be in physical proximity to one another. For example, input data and/or output data may be remotely transmitted from one physical location to another. In addition, programs that implement various aspects of this invention may be accessed from a remote location (e.g., a server) over a network. Such data and/or programs may be conveyed through any of a variety of machine-readable medium including, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices.

Embodiments of the present invention may be encoded upon one or more non-transitory computer-readable media with instructions for one or more processors or processing units to cause steps to be performed. It shall be noted that the one or more non-transitory computer-readable media shall include volatile and non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present invention may further relate to computer products with a non-transitory, tangible computer-readable medium that have computer code thereon for performing various computer-implemented operations. The media and computer code may be those specially designed and constructed for the purposes of the present invention, or they may be of the kind known or available to those having skill in the relevant arts. Examples of tangible computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter. Embodiments of the present invention may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present invention. One skilled in the art will also recognize that a number of the elements described above may be physically and/or functionally separated into sub-modules or combined together.

In summary, systems and method for matching identity and readily accessible personal identifier information based on transaction timestamp are described herein. The method comprises collecting associated transaction information; collecting, by one or more sensors, readily accessible personal identifier information of the member with timestamp; computing, by a processor, one or more similarity scores based on the collected readily accessible personal identifier information and historical readily accessible personal identifier information that was collected during previous transactions of the member; and determining, by the processor, if there is a match between transaction information and the collected readily accessible personal identifier information based on the one or more similarity scores.

The transaction information includes timestamp, member identity, transaction location, and other information collected during the transaction. Readily accessible personal identifier information includes non-biometric information such as ear buds, glasses, earrings, clothes, bags, hats, and signatures of electronic devices. The signatures of electronic devices is a MAC address of the electronic devices. One or more sensors comprise one or more cameras operable to acquire one or more images for facial recognition.

The method further comprises, validating an identity of the member if the match is determined; collecting, by one or more other sensors, other biometric information of member's activity in a member's facility; communicating a status and activities of the member at a member's facility to a third party.

Another method comprises collecting and pre-processing a member's data; building a correlation matrix; extracting matches from matrix processing via successive cancellation; selecting best match from the correlation matrix; and determining if the best match meets a criteria. If the best match meets the criteria, validating the best match. If the best match meets the criteria, deleting the most recent member identification and picture profile from the correlation matrix, recalculate the correlation matrix, then select a next best match from modified correlation matrix. The member's data includes information on member identification, picture profiles, picture indexes, check-in events, number of check-in events for member, timestamp for check-in events for member, and timestamp for pictures.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A method comprising:
collecting associated transaction information of a transaction of a member;
collecting, by one or more sensors, readily accessible personal identifier information of the member;
computing, by a processor, one or more similarity scores based on the collected readily accessible personal identifier information and historical readily accessible personal identifier information that was collected during previous transactions of the member; and
determining, by the processor, if there is a match between transaction information and the collected readily accessible personal identifier information based on the one or more similarity scores.

2. The method of claim 1, wherein the associated transaction information comprises a timestamp of the transaction of the member, member identity, transaction location, and other information collected during the transaction.

3. The method of claim 1, wherein the readily accessible personal identifier information comprises non-biometric information that comprises one or more of the following: ear buds, glasses, earrings, clothes, bags, hats, and signatures of electronic devices.

4. The method of claim 3, wherein the signatures of electronic devices is a MAC address, Bluetooth address (BD_ADDR), or other unique ID of the electronic devices.

5. The method of claim 1, wherein readily accessible personal identifier information comprises biometric information that comprises one of more of the following: profile picture, voice profile, fingerprint, gait, and other features that can be mapped to the member.

6. The method of claim 1, wherein a profile picture is a group of pictures belonging to one member.

7. The method of claim 1, further comprising, validating an identity of the member if the match is determined.

8. The method of claim 1, wherein the one or more sensors comprise one or more cameras operable to acquire one or more images for facial recognition.

9. The method of claim 1, further comprising, collecting, by one or more other sensors, other biometric information of member's activity in a member's facility.

10. The method of claim 1, further comprising, communicating a status and activities of the member at a member's facility to a third party.

11. The method of claim 1, wherein for each readily accessible personal identifier information, a similarity score is computed against all profiles of the member.

12. The method of claim 1, wherein the readily accessible personal identifier information comprises collected biometric information and collected non-biometric information.

13. The method of claim 12, wherein the determination of if there is a match is based on the transaction information and the collected biometric information, or 2) the transaction information and the collected non-biometric information, or 3) the transaction information and the collected biometric information and the collected non-biometric information, or 4) item 3) and historical biometric information.

14. A method comprising:
collecting and pre-processing a member's data;
building a correlation matrix;
extracting matches from matrix processing via successive cancellation;
selecting best match from the correlation matrix; and
determining if the best match meets a criteria.

15. The method of claim 14, further comprising: if the best match meets the criteria, validating the best match.

16. The method of claim 14, wherein a pre-determined threshold is based on a sum of scores for check-in events, and wherein the best match is based on the pre-determined threshold.

17. The method of claim 14, further comprising: if the best match meets the criteria, deleting most recent member identification and picture profile from the correlation matrix, recalculate the correlation matrix, then select a next best match from a modified correlation matrix.

18. The method of claim 14, wherein the member's data includes information on member identification, picture profiles, picture indexes, check-in events, number of check-in events for member, timestamp for check-in events for member, and timestamp for pictures.

19. A non-transitory computer readable storage medium having computer program code stored thereon, the computer program code, when executed by one or more processors implemented on a system, causes the system to perform a method comprising:
collecting associated transaction information of a transaction of a member;
collecting readily accessible personal identifier information of the member;
computing one or more similarity scores based on the collected readily accessible personal identifier information and historical readily accessible personal identifier information that was collected during previous transactions of the member; and
determining if there is a match between transaction information and the collected readily accessible personal identifier information based on the one or more similarity scores; and
validating an identity of the member if the match is determined.

20. The method of claim 19, wherein the readily accessible personal identifier information comprises biometric information and non-biometric information.
